(19) United States
(12) Patent Application Publication
(10) Pub. No.: US 2019/0270652 A1
(43) Pub. Date: Sep. 5, 2019

(54) COMPOSITE FILTER CARTRIDGE

(71) Applicant: XIAMEN FILTERTECH INDUSTRIAL CORPORATION, Xiamen (CN)

(72) Inventors: Xian-Liang Guo, Xiamen (CN); Feng-Shun Zhan, Xiamen (CN)

(21) Appl. No.: 16/288,107

(22) Filed: Feb. 28, 2019

(30) Foreign Application Priority Data
Mar. 1, 2018 (CN) 201810171576.2

(51) Int. Cl. C02F 1/44; B01D 61/02; B01D 61/08; B01D 39/20; C02F 1/00

(52) U.S. Cl. CPC C02F 1/441; B01D 61/025; C02F 2201/006; B01D 39/2055; C02F 1/003; B01D 61/08

(57) ABSTRACT

A composite filter cartridge includes a RO film filter cartridge and a carbon rod filter cartridge. A water outlet end of the RO film filter cartridge used for passing filtered water is connected to a water inlet end of the carbon rod filter cartridge; and a water outlet end of the carbon rod filter cartridge is connected to the water outlet end of the RO film filter cartridge.

### BACKGROUND OF THE INVENTION

### Field of the Invention

The present invention relates to a filter cartridge, and in particular to a composite filter cartridge used in a water purifier.

### The Prior Arts

In general, the RO (Reverse Osmosis) water purifying principle is also referred to as a Reverse Osmosis (RO) principle, that is currently utilized worldwide in water purifier, to perform filtering of raw water (physics method), then the water treated can be drinkable directly, without the need to add any compounds (so the water purifier is also referred to as a terminal water purifying device). For this reason, RO water purifier is now very popular in the market, and is widely accepted by the consumers. However, the present water purifier has a rather large volume, and it occupies quite a large space of a household especially for the city dwellers. The reason for this is that, the RO film filter cartridge and the carbon rod filter cartridge utilized presently in a RO water purifier are two separate pieces, and that requires to use two separate installation spaces. Therefore, the water purifier is voluminous and occupies quite a large space, thus it can not be fitted into limited space in a household.

Therefore, presently, the design and performance of a water purifier is not quite satisfactory, and it leaves much room for improvements.

### SUMMARY OF THE INVENTION

In view of the problems and drawbacks of the prior art, the present invention provides a composite filter cartridge, that is novel in design, and easy in operation.

The present invention provides a composite filter cartridge, that includes: a RO film filter cartridge and a carbon rod filter cartridge. Wherein, a water outlet end of the RO film filter cartridge used for passing filtered water is connected to a water inlet end of the carbon rod filter cartridge, and a water outlet end of the carbon rod filter cartridge is connected to the water outlet end of the RO film filter cartridge.

In an aspect of the present invention, the RO film filter cartridge includes a water outlet tube and a RO film sleeved around the outer perimeter of a water output end of the water outlet tube. The RO film and the outer perimeter of the water outlet tube are formed into a water passage channel for the filtered water to pass through. The water passage channel is connected to the water inlet end of the carbon rod filter cartridge.

In another aspect of the present invention, the carbon rod filter cartridge includes a shell body, and the water outlet connector is disposed in a central portion of the shell body and is connected to the water outlet tube]. In the shell body] is disposed a carbon rod, on the shell body is disposed a water inlet channel connecting the carbon rod] and the water passage channel. The water outlet connector is connected to a water outlet end of the carbon rod used for filtering water.

In a yet another aspect of the present invention, the water inlet channel is formed by a gap between the shell body and an outer perimeter of the water outlet connector, and a check valve is disposed on the water passage channel.

In a further aspect of the present invention, the carbon rod filter cartridge can be inserted into and connected to a lower end of the RO film filter cartridge, a lug is disposed on an upper portion of the carbon rod filter cartridge. On the RO film filter cartridge is disposed a vertical groove and a horizontal groove connected to each other.

Compared with the Prior Art, the composite filter cartridge of the present invention has the following advantages: firstly, it could drastically reduce its volume and the space it occupies. Secondly, since the service life of the RO film filter cartridge is longer, while the service life of the carbon rod filter cartridge is shorter, so that when their respective service lives are approaching, they can be replaced separately and conveniently at different times, to achieve maximum utilization of the respective filter cartridges.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a composite filter cartridge according to the present invention;

FIG. 2 is a cross section view of a composite filter cartridge according to the present invention;

FIG. 3 is a cross section view of a RO film filter cartridge according to the present invention; and

FIG. 4 is a cross section view of a carbon rod filter cartridge according to the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the following, an embodiment is used to describe the various details of the present invention. However, it does not mean that this embodiment represents all the embodiments of the present invention. Other embodiments can be envisaged by people familiar with this field, and thus they all fall into the scope of the present invention.

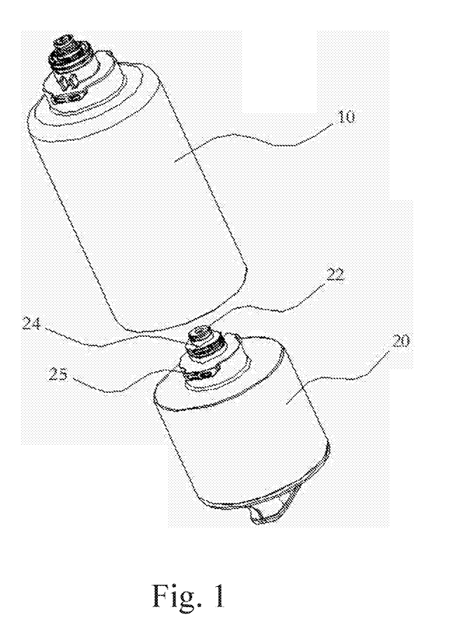

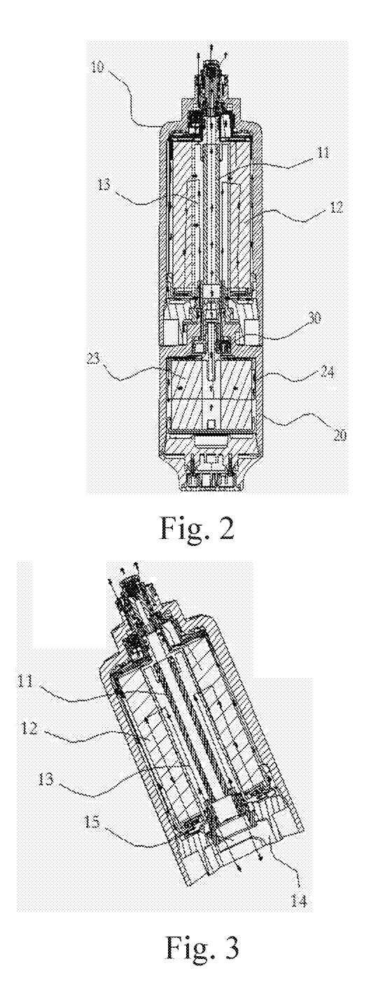

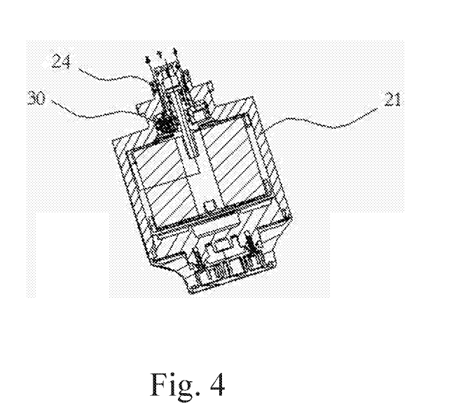

Refer to FIGS. 1-4 respectively for a schematic diagram of a composite filter cartridge according to the present invention; a cross section view of a composite filter cartridge according to the present invention; a cross section view of a RO film filter cartridge according to the present invention; and a cross section view of a carbon rod filter cartridge according to the present invention.

As shown in FIGS. 1-4, the present invention provides a composite filter cartridge, that includes: a RO film filter cartridge 10 and a carbon rod filter cartridge 20.

A water outlet end of the RO film filter cartridge 10 used for passing filtered water is connected to a water inlet end of the carbon rod filter cartridge 20, and a water outlet end of the carbon rod filter cartridge 20 is connected to the water outlet end of the RO film filter cartridge 10.

In an embodiment of the present invention, the RO film filter cartridge 10 includes a water outlet tube 11 and a RO film 12 sleeved around an outer perimeter of a water output end of the water outlet tube 11. The RO film 12 and the outer perimeter of the water outlet tube 11 are formed into a water passage channel 13 for the filtered water to pass through. The water passage channel 13 is connected to the water inlet end of the carbon rod filter cartridge 20.

In an embodiment of the present invention, the carbon rod filter cartridge 20 includes a shell body 21, and the water outlet connector 22 is disposed in a central portion of the shell body 21 and is connected to the water outlet tube 11. In the shell body 21 is disposed a carbon rod 23, on the shell body 21 is disposed a water inlet channel 24 connecting the carbon rod 23 and the water passage channel 13. The water outlet connector 22 is connected to a water outlet end of the carbon rod 23 used for filtering water. The water inlet channel 24 is formed by a gap between the shell body 21 and an outer perimeter of the water outlet connector 22, and a check valve 30 is disposed on the water passage channel 13.

In an embodiment of the present invention, the carbon rod filter cartridge 20 can be inserted into and connected to a lower end of the RO film filter cartridge 10, a lug 25 is disposed on an upper portion of the carbon rod filter cartridge 20. On the RO film filter cartridge 10 is disposed a vertical groove 14 and a horizontal groove 15 connected to each other.

In installation, the lug 25 is aligned with the vertical groove 14, then the carbon rod filter cartridge 20 is inserted into the RO film filter cartridge 10, to make the lug 25 disposed in and connected to the horizontal groove 15, so that the carbon rod filter cartridge 20 and the RO film filter cartridge 10 are connected firmly together. In detaching, all that is required to do is to rotate the carbon rod filter cartridge 20, to align the lug 25 with the vertical groove 14, then pull the carbon rod filter cartridge 20 out from the RO film filter cartridge 10, to achieve detaching easily and conveniently.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A composite filter cartridge, comprising: a RO film filter cartridge and a carbon rod filter cartridge, wherein a water outlet end of the RO film filter cartridge used for passing filtered water is connected to a water inlet end of the carbon rod filter cartridge, and a water outlet end of the carbon rod filter cartridge is connected to the water outlet end of the RO film filter cartridge.

2. The composite filter cartridge as claimed in claim 1, wherein the RO film filter cartridge includes a water outlet tube and a RO film sleeved around an outer perimeter of a water output end of the water outlet tube, the RO film and the outer perimeter of the water outlet tube are formed into a water passage channel for the filtered water to pass through, the water passage channel is connected to the water inlet end of the carbon rod filter cartridge.

3. The composite filter cartridge as claimed in claim 2, wherein the carbon rod filter cartridge includes a shell body, and the water outlet connector is disposed in a central portion of the shell body and is connected to the water outlet tube, in the shell body is disposed a carbon rod, on the shell body is disposed a water inlet channel connecting the carbon rod and the water passage channel, and the water outlet connector is connected to a water outlet end of the carbon rod used for filtering water.

4. The composite filter cartridge as claimed in claim 3, wherein the water inlet channel is formed by a gap between the shell body and an outer perimeter of the water outlet connector, and a check valve is disposed on the water passage channel.

5. The composite filter cartridge as claimed in claim 4, wherein the carbon rod filter cartridge is inserted and connected to a lower end of the RO film filter cartridge, a lug is disposed on an upper portion of the carbon rod filter cartridge, on the RO film filter cartridge is disposed a vertical groove and a horizontal groove connected to each other.
